(19) United States
(12) Patent Application Publication
(10) Pub. No.: US 2021/0276688 A1
(43) Pub. Date: Sep. 9, 2021

(54) Shaped Composite Vehicle Skins and Method for High Rate Manufacturing of Same

(71) Applicant: Galactic Co., LLC, Mojave, CA (US)

(72) Inventors: Rob Sjostedt, Tehachapi, CA (US); Steve Slaughter, Lancaster, CA (US)

(73) Assignee: Galactic Co., LLC, Mojave, CA (US)

(21) Appl. No.: 17/192,833

(22) Filed: Mar. 4, 2021

Related U.S. Application Data
(60) Provisional application No. 62/986,194, filed on Mar. 6, 2020.

(51) Int. Cl. B64C 1/12; B29C 70/38; B29C 70/34; B29C 70/54

(52) U.S. Cl. CPC B64C 1/12; B29C 70/382; B64C 2001/0072; B29C 70/545; B29C 70/34

(57) ABSTRACT

A method for making large vehicle body sections, skins, and panels, including three dimensional sections, skins, and panels, using carbon fiber filaments comingled with thermoplastic polymer filaments to form comingled fibers. The first step is the manufacture of a composite preform using the comingled fibers. The comingled fibers are chopped by a fiber chopper unit mounted on a robot arm to create chopped comingled fibers that are sprayed and set on a preform mold to create a comingled fiber preform. The second step is forming the comingled fiber preform into a composite laminate using heat and pressure to consolidate the comingled fibers on a tooling surface. The disclosed method can be used for making large and contoured thermoplastic composite panels, skins, or sections suitable for light aircraft, automobiles, eVTOL's and other panel applications at a high production rate.

### CROSS-REFERENCE TO RELATED APPLICATION

This application claims priority under 35 USC Section 119(e) to co-pending U.S. Provisional Patent Application No. 62/986,194, filed on Mar. 6, 2020, the entire disclosure of which is incorporated herein by reference.

### FIELD OF THE INVENTION

This invention relates generally to shaped composite laminates and methods for high rate manufacturing of same.

### BACKGROUND OF THE INVENTION

Relatively small vehicles such as cars, airplanes, helicopters, and electric vertical takeoff and landing (eVTOL) urban transport aircraft require an external body shell structure to encapsulate the passengers and systems. There are many existing methods to make such vehicle external shell structures, such as formed metal, plastic, and composite materials. However, each such method has attributes and disadvantages depending on the vehicle requirements. Furthermore, for any given application, the material and manufacturing process must meet functional, cost, and manufacturing requirements.

For example, steel sheet metal has been the dominate automotive body panel manufacturing method because it is low cost, easily formed, highly durable, and the manufacturing method meets automotive production rate requirements. However, steel sheet metal is heavy and has a propensity to rust.

As another example, aluminum has been the dominate material for use in the manufacture of small aircraft and helicopter body shells and skins because aluminum is lightweight and can easily be formed to body panel shapes. However, aluminum body panels must be riveted to the supporting framework which is time consuming and costly. Furthermore, aluminum has corrosion and fatigue concerns.

Advanced composite materials such as carbon fiber and epoxy provide for a lightweight, strong, corrosion resistant, and fatigue resistant structure, but the materials and manufacturing processes are slow and more costly.

The body shell for urban transport vehicles and aircraft, such as eVTOLs, is a significant material and process challenge because the body shell must be very lightweight, strong, low cost, and capable of being manufactured at high rates. To be cost effective for an urban transport vehicle, it is desirable to be able to manufacture the body shell at rates close to one unit per hour.

A second objective for high-volume production of urban transport vehicles and aircraft, such as eVTOLs and other similar vehicles, is to make the body shell structure in as few segments as possible to eliminate assembly time and cost. To date, advanced composite body shell structures have not been made in large sizes and at costs and production rates suitable for the high rate of manufacture needed for urban transport vehicles and aircraft, such as eVTOLs.

The set of requirements for a high-volume produced vehicles such as automobiles, aircraft and urban mobility eVTOL aircraft are extensive. In addition to meeting basic requirements for function, strength, weight, cost, and manufacturing rate, modern products must meet a high standard of appearance and preferably be recyclable at end of life.

Thermoplastic matrix advanced composite materials have many attractive features for the body shell structure of small vehicles such as cars, airplanes, helicopters and eVTOL aircraft. Carbon fibers combined with a thermoplastic polymer such as polyetheretherketone (PEEK), polyaryletherketone (PAEK), polyphenylene sulfide (PPS), and polyetherimide (PEI) can make a strong, lightweight, and damage resistant body shell structure. Thermoplastic materials are also recyclable. As a material, thermoplastic composites potentially do not require long processing times like those for thermosetting polymer materials.

While thermoplastic composite materials offer many attractive features for a lightweight vehicle body shell, many significant processing challenges exist. For example, high molding pressures (200 psi+) and high molding temperatures (500 F+) are typically required to form and consolidate a carbon fiber thermoplastic material into a thin, high-strength composite laminate suitable for a vehicle skin panel. These processing requirements are not an issue for small parts. A hydraulic press can be used to create molding die pressure. Various means to heat and cool down a tool for a small part exist.

However, to make larger skin panels and parts, there exists a need and desire to create adequate heat, pressure, and cool down at a cost effective rate. Currently, large thermoplastic parts and skins are often consolidated in an autoclave so there is no reduction in processing time compared to thermosetting materials, and production rates are not suitable for high volume production. For these reasons, a new process that mitigates the high pressure and heat and cool cycle requirements for molding large thermoplastic composite laminates or vehicle skins is disclosed.

### BRIEF SUMMARY OF THE INVENTION

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

The invention disclosed and described herein is directed to composite laminates and vehicle body panels, parts, and skins that are too large to be compression molded by conventional techniques and that would be too slow to produce if made by autoclave processing, and to a method for making same.

The disclosed invention can be used for making large thermoplastic composite laminates such as large and contoured thermoplastic composite panels or sections suitable for light aircraft, automobiles, eVTOL's and other panel applications at a high production rate.

While primarily directed at lightweight vehicle shell skins that are supported by frame structures, this invention can also be used for other vehicle component skins such as wing skins in certain applications where chopped fiber composite material strength is acceptable. In addition to making three-dimensional shells or skins, the disclosed method can also be used for making flat panels.

This method for manufacturing large thermoplastic laminates such as skin panels is divided into two primary processes. The first process is the manufacture of a composite preform, and the second process is consolidating that preform into a laminate.

The first process is the manufacture of a composite preform using carbon fiber filaments comingled with thermoplastic polymer filaments to form comingled fibers. The comingled fibers are chopped by a fiber chopping unit mounted on a robot arm to create chopped comingled fibers that are sprayed and set on a preform mold to create a comingled fiber preform.

The second process is forming the comingled fiber preform into a composite laminate using heat and pressure via a consolidation tool to consolidate the comingled fibers on a tooling surface.

The two-step process is optimized for high-rate production because it increases the production rate as the forming of the comingled fiber preform is occurring simultaneously with the consolidation of the composite laminate in two separate operations.

However, in an alternative embodiment, the comingled fibers can also be chopped and sprayed by fiber chopper unit directly onto consolidation tool if production rate is less of a concern. In this embodiment, two robot arms can be utilized concurrently, with the first robot arm preforming preform manufacture and the second robot arm then performing the consolidation process.

Prior art fiber chopping units only have one rotary drum with a fixed number of cutting blades so they can only cut one length of fiber at a time. Therefore, in another embodiment, an option to vary the length of the chopped comingled fiber to either be longer or shorter during processing is disclosed because in certain applications it may be desirable to use longer fibers in certain high structurally loaded areas and shorter fibers in other areas.

In this embodiment, the fiber chopping unit has two rotary drums built into the fiber chopper unit to cut different lengths of chopped comingled fibers. The smaller rotary drum is used to make short length chopped comingled fibers. The larger diameter rotary drum has fewer blades and therefore produces longer chopped comingled fibers. The rotary drums rotate on a rotating platform so one or the other can engage and bear against the drive drum.

The change in fiber length can also be controlled with computer numerical control along with the robot arm used for applying the chopped comingled fibers to the preform mold. Computer numerical control can be used to rotate one rotary drum out of use and bring the other into use thereby changing the length of fibers cut.

Another alternative embodiment for manufacturing large composite vehicle skins and parts using the two-step process disclosed herein is to utilize carbon fiber felt, or mat, with a Polyphenylene Sulfide (PPS) matrix in powder that is sprinkled throughout the carbon fiber felt as it is manufactured such that the polymer is evenly distributed amongst the carbon fiber fibers.

In other embodiments, other fiber forms and other thermoplastic polymers may be combined in a similar manner to make a felt-like material or mat that can be consolidated into a composite laminate using the two-step process disclosed herein.

Accordingly, one or more embodiments of the present invention overcomes one or more of the shortcomings of the known prior art.

For example, in one embodiment, a method of manufacturing a composite laminate comprises providing a plurality of carbon fiber filaments comingled with a plurality of thermoplastic polymer filaments to form a plurality of comingled fibers; chopping the plurality of comingled fibers with a fiber chopper unit mounted on a robot arm to form a plurality of chopped comingled fibers; spraying the plurality of chopped comingled fibers onto a preform mold; setting the plurality of chopped comingled fibers on the preform mold to form a comingled fiber preform; directing heat energy from a heating unit onto the comingled fiber preform to melt the plurality of thermoplastic polymer filaments; applying pressure to the comingled fiber preform to consolidate the comingled fiber preform; and cooling the comingled fiber preform to form a composite laminate.

In this embodiment, the method can further comprise controlling the fiber chopper unit using computer numerical control; applying pressure comprises rolling a roller over the comingled fiber preform; controlling the roller using computer numerical control; or controlling the heating unit using computer numerical control.

In another example embodiment, a method of manufacturing a composite laminate comprises providing a comingled felt comprising a plurality of carbon fibers and a thermoplastic polymer; forming the comingled felt into a preform shape; directing heat energy from a heating unit onto the comingled felt to melt the thermoplastic polymer; rolling the comingled felt with a compaction roller; and cooling the comingled felt to form a composite laminate.

In another example embodiment a composite laminate manufactured by a process comprises the steps of providing a plurality of carbon fiber filaments comingled with a plurality of thermoplastic polymer filaments to form a plurality of comingled fibers; chopping the plurality of comingled fibers with a fiber chopper unit mounted on a robot arm to form a plurality of chopped comingled fibers; spraying the plurality of chopped comingled fibers onto a preform mold; setting the plurality of chopped comingled fibers on the preform mold to form a comingled fiber preform; directing heat energy from a heating unit onto the comingled fiber preform to melt the thermoplastic polymer filaments; applying pressure to the comingled fiber preform to consolidate the comingled fiber preform; and cooling the comingled fiber preform to form a composite laminate.

In this embodiment, composite laminate manufactured by the process can further comprise controlling the fiber chopper unit using computer numerical control; applying pressure comprises rolling a roller over the comingled fiber preform; controlling the roller using computer numerical control; or controlling the heating unit using computer numerical control.

In another example embodiment a composite laminate manufactured by a process comprises the steps of providing a comingled felt comprising a plurality of carbon fibers and a thermoplastic polymer; forming the comingled felt into a preform shape; directing heat energy from a heating unit onto the comingled felt to melt the thermoplastic polymer; rolling the comingled felt with a compaction roller; and cooling the comingled felt to form a composite laminate.

Other objects, features, and advantages of the present invention will become apparent upon consideration of the following detailed description and the accompanying drawings.

### BRIEF DESCRIPTION OF THE DRAWINGS

FIG. 1 illustrates an example of comingled carbon fiber filaments and thermoplastic polymer filaments.

FIG. 2 illustrates a side view of a robot application machine for chopping and spraying comingled fibers onto a screen mold to make comingled fiber preforms.

FIG. 3 illustrates a top-side view of the robot application machine for chopping and spraying comingled fibers onto a screen mold to make comingled fiber preforms.

FIG. 4 illustrates an example flow diagram for the preform manufacture process of the present invention.

FIG. 5 illustrates a top-side view of the consolidation tool for consolidated the comingled fiber preform into a fully consolidated laminate.

FIG. 6 illustrates a side view of the consolidation tool for the directed heat energy and roller consolidation for the consolidation process.

FIG. 7 illustrates an example flow diagram for the consolidation process of the present invention.

FIG. 8 illustrates a side elevational view of an example of a partially consolidated comingled composite laminate.

FIG. 9 illustrates a side elevational view of an example of a fully consolidated comingled composite laminate.

FIG. 10 illustrates a side elevational view of an example of a carbon fiber/pps felt.

FIG. 11 illustrates an example of a fiber chopping unit that has a first and second rotary drum built into the fiber chopper unit to cut different lengths of chopped comingled fibers.

### DETAILED DESCRIPTION OF THE INVENTION

The following is a detailed description of embodiments to illustrate the principles of the invention. The embodiments are provided to illustrate aspects of the invention, but the invention is not limited to any embodiment. The scope of the invention encompasses numerous alternatives, modifications, and equivalents. The scope of the invention is limited only by the claims.

While numerous specific details are set forth in the following description to provide a thorough understanding of the invention, the invention may be practiced according to the claims without some or all of these specific details.

Various embodiments will be described in detail with reference to the accompanying drawings. Wherever possible, the same reference numbers are used throughout the drawings to refer to the same or like parts. References made to particular examples and implementations are for illustrative purposes and are not intended to limit the scope of the claims.

Comingled Fibers

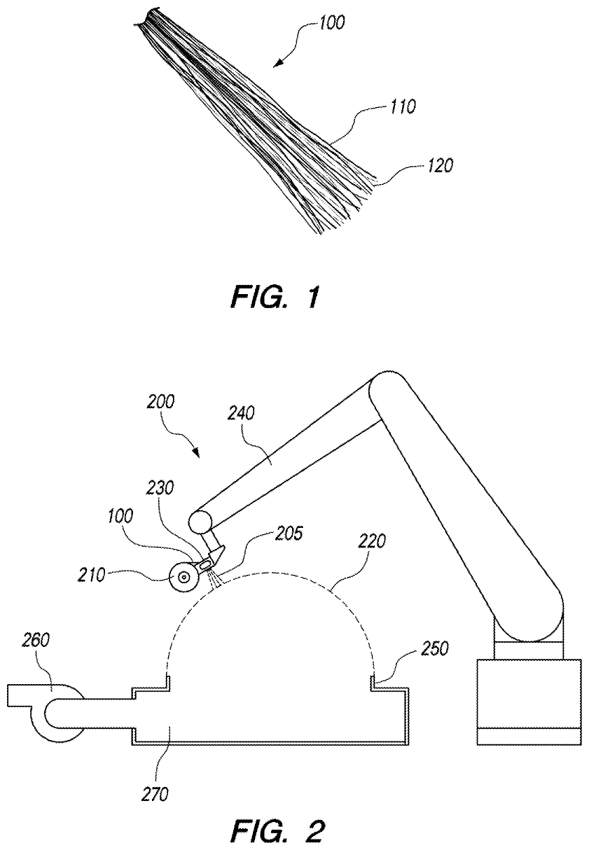

As shown in FIG. 1, the materials used for comingled fibers 100, sometimes referred to as a carbon fiber tow, comprise carbon fiber filaments 110 comingled with thermoplastic polymer filaments 120. In an example embodiment, the ratio of carbon fiber filaments 110 to thermoplastic polymer filaments 120 is roughly 60 percent to 40 percent by volume. However, higher or lower volume ratios for the thermoplastic polymer filaments 120 to the carbon fiber filaments 110 can also be used and be beneficial for some applications.

Examples of thermoplastic polymer filaments 120 include polyetheretherketone (PEEK), polyaryletherketone (PAEK), polyphenylene sulfide (PPS), and polyetherimide (PEI). However, other suitable thermoplastic polymer filaments 120 at different ratios can also be used.

In one example embodiment, carbon fiber is used as a reinforcing fiber for aircraft, helicopters, eVTOL, and even lightweight automobiles. However, glass fibers with comingled thermoplastic filaments can also be used in an alternative embodiment.

Robot Application Machine

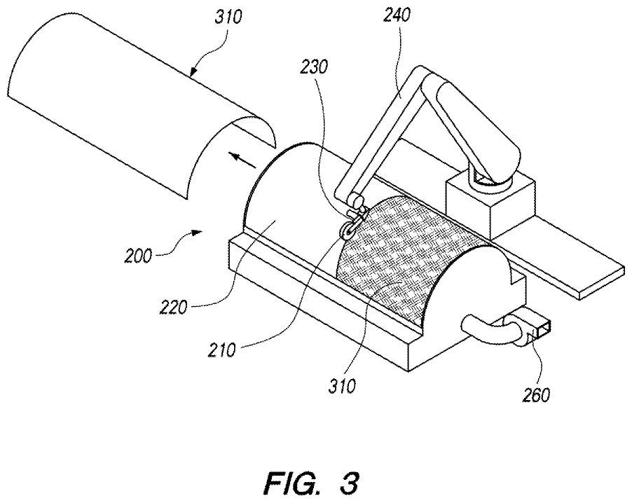

As shown in FIGS. 2 and 3, robot application machine 200 is used for chopping spraying, and applying comingled fibers 100 onto a preform mold 220 to make comingled fiber preform 310 as shown in FIG. 3.

As shown in FIG. 2, comingled fibers 100 are wound on comingled fiber supply spool 210. The comingled fibers 100 are continuously delivered from comingled fiber supply spool 210 to fiber chopper unit 230 mounted on robot arm 240. Fiber chopper unit 230 is electronically controlled, such as by a computer, to continuously apply short lengths of comingled fibers 100 at a high rate of speed to the preform mold 220. In an example embodiment, the short lengths of comingled fibers 100 are one to three inches long.

In an alternative embodiment, carbon fiber filaments 110 and thermoplastic polymer filaments 120 can be independently fed through the fiber chopper unit 230 rather than comingling the two materials together into comingled fibers 100. In another alternative embodiment, pre-impregnated carbon fiber often called tow-preg can be fed into the fiber chopper unit 230. In the case of the tow-preg, it will be higher cost due to the pre-preg operation.

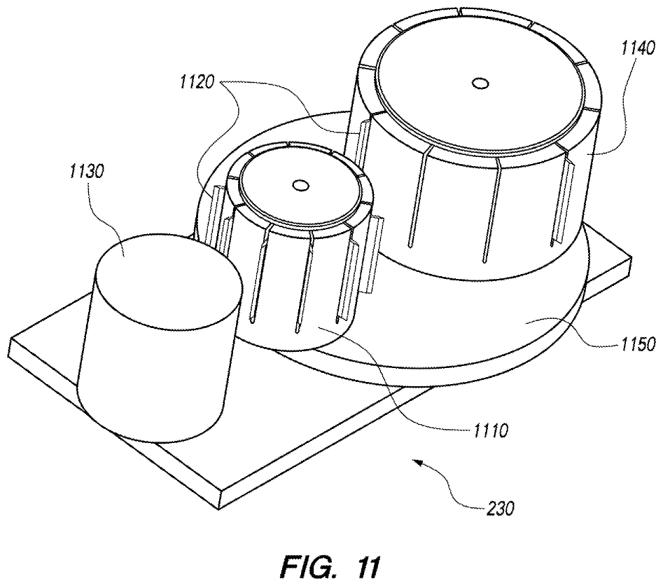

As shown in FIG. 11, in one example embodiment, fiber chopper unit 230 has a first rotary drum 1110 with a cutter blades 1120 such that it cuts comingled fibers 100 against drive drum 1130 one time with each revolution of first rotary drum 1110 to create chopped comingled fibers 205. The number of cutter blades 1120 determines the length of the chopped comingled fibers 205.

Fiber chopping unit 230 can also comprise a second rotary drum 1140 to cut different lengths of chopped comingled fibers 205. In one example embodiment, the second rotary drum 1140 has a larger diameter than first rotary drum 1110 and fewer cutter blades 1120, and therefore produces longer chopped comingled fibers 205. The first rotary drum 1110 and second rotary drum 1140 can rotate on rotating platform 1150 to engage and bear against the drive drum 1130 as required to cut chopped comingled fibers 205.

In one example embodiment, the length of chopped comingled fibers 205 can also vary by mechanically retracting one or more of cutter blades 1120 in the first rotary drum 1110 and/or second rotary drum 1140 used to cut the length of chopped comingled fibers 205 or by using computer numerical control to switch between first rotary drum 1110 and second rotary drum 1140.

Compressed air provides the delivery of comingled fibers 100 through fiber chopper unit 230. A binder material can be sprayed with chopped comingled fibers 205 so that the short lengths of lightweight chopped comingled fibers 205 adhere as they are blown onto the preform mold 220.

In one example embodiment, preform mold 220 is a half circle or doom shape form for a lightweight air vehicle such as an eVTOL. In one embodiment, preform mold 220 can be made of metal hardware cloth, wire screen, or wire mesh that has been formed to the shape of the vehicle body.

Preform mold 220 is mounted to a work surface 250 that has a plenum 270 underneath it. Blower 260 pulls air from the inner space of the plenum 270, which aids in adhering the chopped comingled fibers 205 to the outer surface of the preform mold 220. In one example embodiment, blower 260 is a large squirrel cage type blower or other high volume, low pressure blower.

Preform Manufacture Process

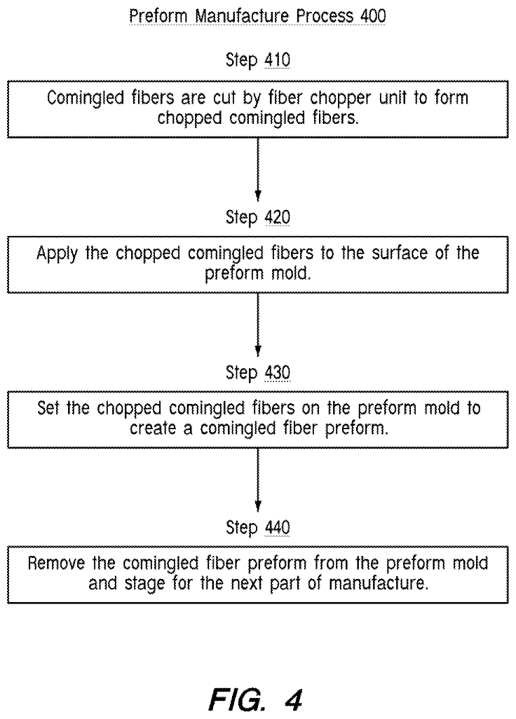

Turning to FIG. 4, the preform manufacture process 400 to make a comingled fiber preform 310 from comingled fibers 100 utilizing the robot application machine 200 is shown.

At Step 410, comingled fibers 100 are continuously delivered from comingled fiber supply spool 210 to fiber chopper unit 230 mounted on robot arm 240. Comingled fibers 100 are then cut by fiber chopper unit 230 to form chopped comingled fibers 205.

At Step 420, chopped comingled fibers 205 are applied or laid down on the surface of preform mold 220. This step can be done using robot arm 240 for manipulating the fiber chopper unit 230. The robot arm 240 is programmed to lay down chopped comingled fibers 205 on the preform mold 220 in a controlled and repeatable manner. This provides an improved method over conventional fiberglass chopped fiber spray-up which is typically done by hand.

In another embodiment, the amount of chopped comingled fibers 205 can be programmed to vary over the surface of the preform mold 220. For example, the robot arm 240 can be programmed to not lay down chopped comingled fibers 205 in areas such as window openings, hatches, and door openings thereby avoiding material waste.

At step 430, chopped comingled fibers 205 are set on the preform mold 220 to create comingled fiber preform 310. This process can vary depending on the type of binder used in conjunction with fiber chopper unit 230. In one embodiment, a water or solvent binder may require infrared heat for a few minutes to set the comingled fiber preform 310. In other embodiments, infrared heat can be applied by overhead lamps or as an end effector on a robot arm. In one embodiment, the random orientation of the chopped comingled fibers 205 creates a quasi-isotropic composite laminate.

In Step 440, the comingled fiber preform 310 is removed from the preform mold 220 and staged for the next part of manufacture. Making the comingled fiber preform 310 on a separate preform mold 220 improves the overall rate production since spray-up time is separated from the thermoplastic consolidation process.

Preform Consolidation Tool

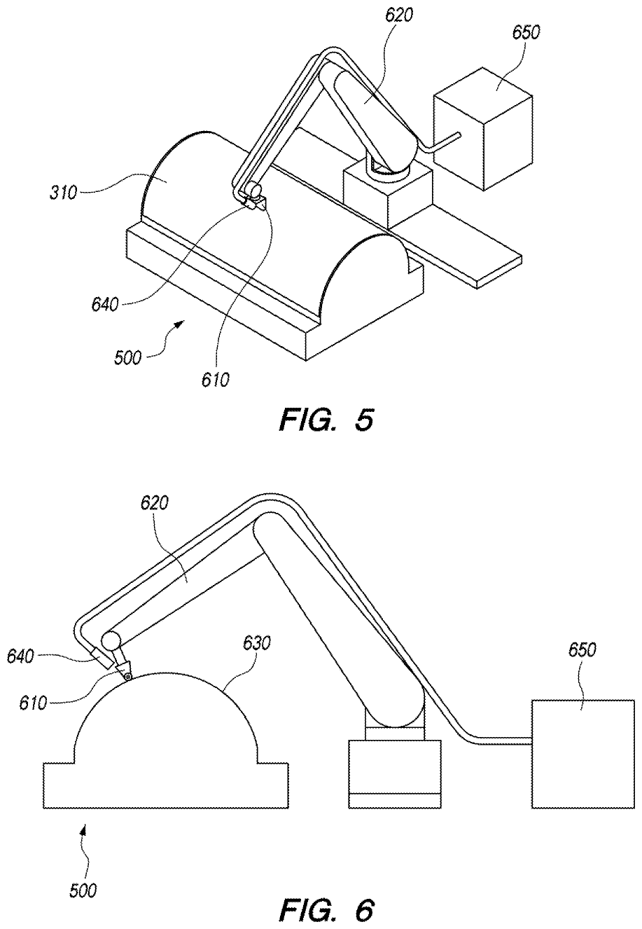

As shown in FIG. 5, comingled fiber preform 310 is placed on consolidation tool 500 that accurately defines the Inner Mold Line (IML) or Outer Mold Line (OML) of the fully consolidated comingled composite laminate 900, as desired for dimensional control.

In one example embodiment, consolidation tool 500 is made from carbon fiber so it has a low coefficient of thermal expansion (CTE), but other tool materials can be used. Consolidation tool 500 is integrally heated to optimize the consolidation process, although consolidation tool 500 is always kept at a lower temperature than the melt point of the thermoplastic polymer filaments 120.

As shown in FIG. 6, roller 610 of consolidation tool 500 applies pressure to consolidate the comingled fiber preform 310 on finish surface 630 of consolidation tool 500. Roller 610 is attached to robot arm 620 that is programmed to pass over the entire finish surface 630. In one-embodiment, roller 610 is a hard or semi-hard roller.

Roller 610 applies line contact pressure on the comingled fiber preform 310, and thus has high local consolidation pressure. Thus, a pneumatic cylinder spring can be incorporated into the end of robot arm 620 to provide compliance to the system.

Heating unit 640 applies heat from heat energy power source 650 to comingled fiber preform 310.

Several options exist for heat energy from heat energy power source 650 through heating unit 640 suitable to melt the thermoplastic polymer filaments 120 of comingled fiber preform 310. In one embodiment, directed heat energy is used. The directed heat energy can be supplied by a laser or pulsed light. An example of a pulsed light system is the Heraeus humm3™ pulsed light technology wherein the pulsed light is controlled in terms of energy, duration, and frequency. In one embodiment, a laser is used for the directed heat energy, although other directed heat energy methods may be used in alternative embodiments.

Consolidation Process

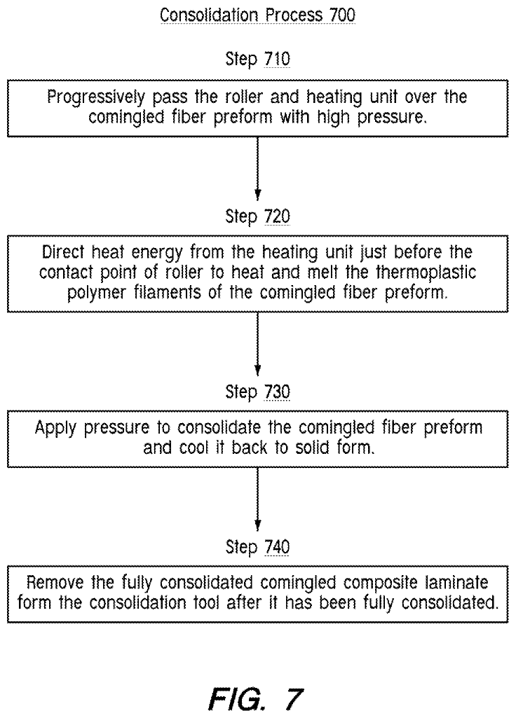

Turning to FIG. 7, the consolidation process 700 to make fully consolidated comingled composite laminate 900 utilizing consolidation tool 500 is shown.

At step 710, roller 610 and heating unit 640 are progressively passed over comingled fiber preform 310 with high pressure thereby pin-rolling the carbon fiber filaments 110 and thermoplastic polymer filaments 120.

At step 720, the directed heat energy from the heating unit 640 is focused just before the contact point of roller 610. The directed heat energy of heating unit 640 heats and melts the thermoplastic polymer filaments 120 of the comingled fiber preform 310.

The directed heat energy must be tailored with consolidation pressure and the rate of movement of the robot arm 620 to optimize the composite laminate 900 produced from the comingled fiber preform 310. The amount of heat energy to put onto the comingled fiber preform 310 just ahead of roller 610 and the traverse speed of the roller is specific to each thermoplastic polymer filament 120 used. For example, PPS requires 500 F+ temperature and 200 psi to consolidate, and other materials like PEEK require in excess of 600 F and similar pressure. Once the process parameters and the allowable deviation is determined, then the robot arm 620 is programmed for that speed and heat input.

At step 730, roller 610 applies pressure to consolidate the comingled fiber preform 310 and cool it back to a solid form. In one embodiment, roller 610 generates 200+ psi pressure required to adequately flow the melted thermoplastic polymer filaments 120 and produce a high strength relatively void free composite laminate 900 from the comingled fiber preform 310.

At step 740, when the entire surface of the fully consolidated comingled composite laminate 900 has been fully consolidated, it is ready for removal from the consolidation tool 500.

Consolidation process 700 performs multiple functions. First, it melts and flows the thermoplastic polymer filaments 120 amongst the carbon fiber filaments 110 in the comingled fiber preform 310. Second, it consolidates the carbon fiber filaments 110 and thermoplastic polymer filaments 120 of the comingled fiber preform 310 into fully consolidated comingled composite laminate 900 with low void content. Third, it is forming the fully consolidated comingled composite laminate 900 to the finish surface 630. Fourth, it is creating a smooth surface on the fully consolidated comingled composite laminate 900 for the non-tool side of the vehicle body.

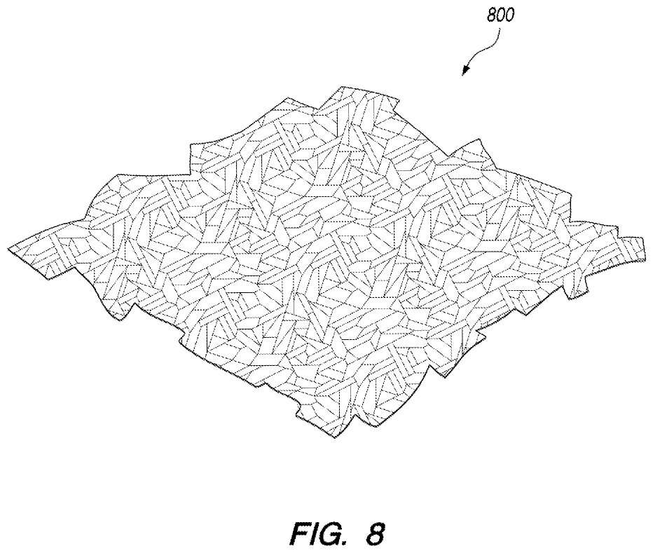

FIG. 8 shows an example of a partially consolidated comingled composite laminate 800.

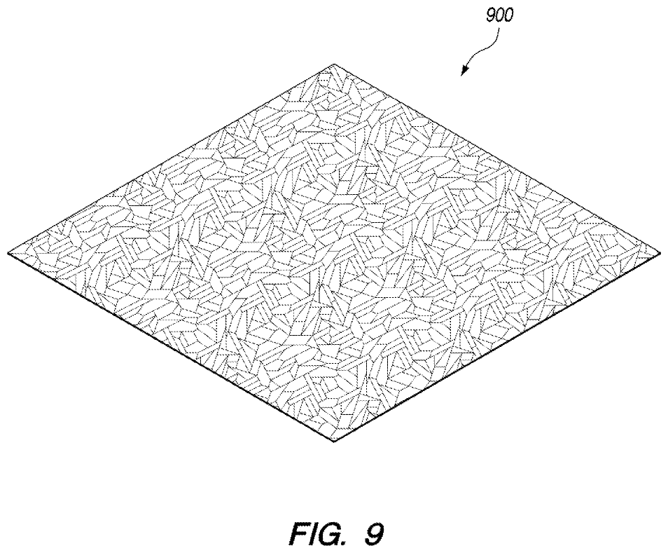

FIG. 9 shows an example of a fully consolidated comingled composite laminate 900.

### Alternate Embodiments

The two-step process of preform manufacture process 400 and consolidation process 700 is optimized for high-rate production because it increases production rate as the forming of comingled fiber preform 310 is occurring simultaneously with the consolidation of the composite laminate 900 in two separate operations.

However, in an alternative embodiment, the comingled fibers 100 can also be chopped and sprayed by fiber chopper unit 230 directly onto consolidation tool 500 if production rate is less of a concern. In this embodiment, two robot arms can be utilized concurrently, with one first preforming preform manufacture process 400 and the second then performing consolidation process 700. The directed energy heat is still applied by heating unit 640 in the same manner with roller 610 consolidating the composite laminate 900 as describe herein.

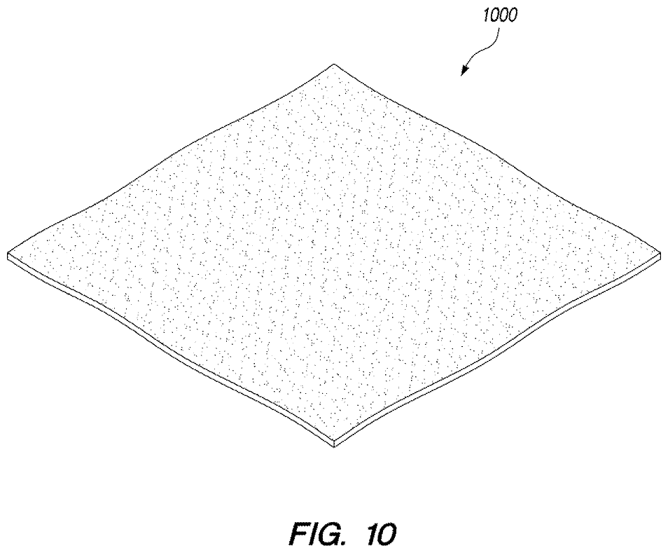

As shown in FIG. 10, another alternative embodiment for manufacturing large composite vehicle skins and parts using preform manufacture process 400 with robot application machine 200 and consolidation process 700 with consolidation tool 500 is to utilize carbon fiber felt, or mat, 1000 with a Polyphenylene Sulfide (PPS) matrix in powder that is sprinkled throughout the carbon fiber felt 1000 as it is manufactured such that the polymer is evenly distributed amongst the carbon fiber fibers.

In other embodiments, other fiber forms and other thermoplastic polymers may be combined in a similar manner to make a felt-like material or mat that can be consolidated into a composite laminate 900 using preform manufacture process 400 with robot application machine 200 and consolidation process 700 with consolidation tool 500.

Such materials in various forms are commercially manufactured and available in sheet form. An example is Mitsubishi Kyron TEX™. The Kyron TEX™ material is available in sheet form delivered on a roll. For example, the material can be manufactured as wide as six feet. The felt material can be cut to flat pattern shapes that can be joined together to approximate a three-dimensional shape such as a composite vehicle skin. The flat pattern shapes can be joined together by sewing or thermoplastic spot welding. When joined together the shaped felt will loosely approximate the shape of the vehicle.

The consolidation process 700 can be used to heat and consolidate the felt preform on the consolidation tool 500. Multiple passes of the roller 610 and heating unit 640 may be required to reduce the loft of the felt down to a high strength consolidated laminate. The consolidation temperature and pressure applied is specific to the material and the thickness of composite laminate 900 to be produced. For example, a carbon fiber PPS comingled laminate processed in this manner will require at least 600 degrees Fahrenheit heat input to melt and flow the thermoplastic filaments and a roller line contact pressure equal to or greater than 200 psi.

While the invention has been specifically described in connection with certain specific embodiments thereof, it is to be understood that this is by way of illustration and not of limitation. Reasonable variation and modification are possible within the scope of the foregoing disclosure and drawings without departing from the spirit of the invention.

We claim:

1. A method of manufacturing a composite laminate comprising:
providing a plurality of carbon fiber filaments comingled with a plurality of thermoplastic polymer filaments to form a plurality of comingled fibers;
chopping the plurality of comingled fibers with a fiber chopper unit mounted on a robot arm to form a plurality of chopped comingled fibers;
spraying the plurality of chopped comingled fibers onto a preform mold;
setting the plurality of chopped comingled fibers on the preform mold to form a comingled fiber preform;
directing heat energy from a heating unit onto the comingled fiber preform to melt the plurality of thermoplastic polymer filaments;
applying pressure to the comingled fiber preform to consolidate the comingled fiber preform; and
cooling the comingled fiber preform to form a composite laminate.

2. The method of claim 1 further comprising controlling the fiber chopper unit using computer numerical control.

3. The method of claim 1 wherein applying pressure comprises rolling a roller over the comingled fiber preform.

4. The method of claim 3 further comprising controlling the roller using computer numerical control.

5. The method of claim 1 further comprising controlling the heating unit using computer numerical control.

6. The method of claim 1 wherein the fiber chopping unit comprises a first rotary drum and a second rotary drum, and further wherein the chopping the plurality of comingled fibers is performed by the first rotary drum and the second rotary drum.

7. A method of manufacturing a composite laminate comprising:
providing a comingled felt comprising a plurality of carbon fibers and a thermoplastic polymer;
forming the comingled felt into a preform shape;
directing heat energy from a heating unit onto the comingled felt to melt the thermoplastic polymer;
rolling the comingled felt with a compaction roller; and
cooling the comingled felt to form a composite laminate.

8. A composite laminate manufactured by a process comprising the steps of:
providing a plurality of carbon fiber filaments comingled with a plurality of thermoplastic polymer filaments to form a plurality of comingled fibers;
chopping the plurality of comingled fibers with a fiber chopper unit mounted on a robot arm to form a plurality of chopped comingled fibers;
spraying the plurality of chopped comingled fibers onto a preform mold;
setting the plurality of chopped comingled fibers on the preform mold to form a comingled fiber preform;
directing heat energy from a heating unit onto the comingled fiber preform to melt the thermoplastic polymer filaments;
applying pressure to the comingled fiber preform to consolidate the comingled fiber preform; and
cooling the comingled fiber preform to form a composite laminate.

9. The composite laminate manufactured by the process of claim 8 further comprising controlling the fiber chopper unit using computer numerical control.

10. The composite laminate manufactured by the process of claim 8 wherein applying pressure comprises rolling a roller over the comingled fiber preform.

11. The composite laminate manufactured by the process of claim 10 further comprising controlling the roller using computer numerical control.

12. The composite laminate manufactured by the process of claim 8 further comprising controlling the heating unit using computer numerical control.

13. The composite laminate manufactured by the process of claim 8 wherein the fiber chopping unit comprises a first rotary drum and a second rotary drum, and further wherein the chopping the plurality of comingled fibers is performed by the first rotary drum and the second rotary drum.

14. A composite laminate manufactured by a process comprising the steps of:
providing a comingled felt comprising a plurality of carbon fibers and a thermoplastic polymer;
forming the comingled felt into a preform shape;
directing heat energy from a heating unit onto the comingled felt to melt the thermoplastic polymer;
rolling the comingled felt with a compaction roller; and
cooling the comingled felt to form a composite laminate.
